(19) United States
(12) Patent Application Publication
(10) Pub. No.: US 2026/0319187 A1
(43) Pub. Date: Oct. 15, 2026

(54) CLEANING METHOD OF SILICON PHOTONICS WAFER TESTING SYSTEM

(71) Applicant: HERMES TESTING SOLUTIONS INC., Hsinchu City (TW)

(72) Inventor: Wen-Yuan Hsu, Hsinchu City (TW)

(73) Assignee: HERMES TESTING SOLUTIONS INC., Hsinchu City (TW)

(21) Appl. No.: 19/312,181

(22) Filed: Aug. 27, 2025

Related U.S. Application Data
(60) Provisional application No. 63/747,347, filed on Jan. 21, 2025.

(30) Foreign Application Priority Data
Apr. 14, 2025 (TW) 114113949

(51) Int. Cl. G02B 6/38; G01N 21/94

(52) U.S. Cl. CPC G02B 6/3866; G01N 21/94; G02B 6/3843

(57) ABSTRACT

Provided is a cleaning method of a silicon photonics wafer testing system. The cleaning method includes the following. An optical fiber array is aligned through an integrated control module driving an upward-facing camera of a wafer prober. A cleaning kit is aligned through the integrated control module driving a downward-facing camera of the wafer prober. Also, the optical fiber array is cleaned through the integrated control module driving the cleaning kit. The optical fiber array is loaded on the optical coupling actuator. The silicon photonics wafer testing system includes the wafer prober having a probe testing platform and the cleaning kit disposed therein, the upward-facing camera, the downward-facing camera, an optical coupling actuator disposed on the probe testing platform, and the integrated control module electrically connected to the wafer prober and the optical coupling actuator.

### CROSS-REFERENCE TO RELATED APPLICATION

This application claims the priority benefits of U.S. provisional application serial no. 63/747,347, filed on Jan. 21, 2025, and Taiwan application serial no. 114113949, filed on Apr. 14, 2025. The entirety of each of the above-mentioned patent applications is hereby incorporated by reference herein and made a part of this specification.

### BACKGROUND

### Technical Field

The disclosure relates to a cleaning method, and particularly relates to a cleaning method of a silicon photonics wafer testing system.

### Related Art

Photonic integrated circuit (PIC) is a well-known technology in the telecommunications field, driving the development of high-speed networks and artificial intelligence (AI). This is mainly attributed to the rapid development of optical transceivers, which are smaller and faster than bulkier discrete optics. From commercial and research perspectives, PICs are also beginning to play a role in other fields (such as chip laboratories, laser technology, or quantum computing).

Current testing of silicon photonics wafers is performed directly after product completion, and the product quality is determined accordingly. However, when a product is determined to be defective due to loss, it is not possible to clearly identify which part (section) of the optical path on the silicon photonics wafer is causing the loss, resulting in yield misreporting. Therefore, clarifying the causes of the loss and proposing solution methods has become a concern for relevant technical personnel.

Current possible causes of loss, in addition to light source attenuation, quality and configuration of optical components, contamination caused by the environment in which objects are located is also one of the reasons. For example, for the optical fiber array that couples with the silicon photonics wafer, dirt on the surface of components in the optical path thereof may cause the misreporting. Alternatively, during the probing process, the wafer prober generates particulates due to mechanical movements thereof, and the scraping action on the surface of the aluminum pads or solder balls caused by probe pressure easily produces debris, which in turn affects the optical path in the environment.

### SUMMARY

The disclosure provides a cleaning method of a silicon photonics wafer testing system, configured to clean an optical fiber array in the silicon photonics wafer testing system, so as to ensure that optical coupling and subsequent testing can eliminate testing errors caused by contamination.

In the cleaning method of the silicon photonics wafer testing system of the disclosure, the silicon photonics wafer testing system includes a wafer prober, an optical coupling actuator, and an integrated control module, in which the integrated control module is electrically connected to the wafer prober and the optical coupling actuator, the wafer prober includes a probe testing platform, a cleaning kit, an upward-facing camera, and a downward-facing camera, the optical coupling actuator is disposed on the probe testing platform, the optical fiber array is loaded on the optical coupling actuator, the upward-facing camera and the downward-facing camera are respectively disposed in the probe testing platform, the optical fiber array extends into the probe testing platform from top to bottom, and the cleaning kit is disposed within the probe testing platform from bottom to top. The cleaning method includes the following. An optical fiber array is aligned through an integrated control module driving an upward-facing camera of a wafer prober. A cleaning kit is aligned through the integrated control module driving a downward-facing camera of the wafer prober. Also, the integrated control module drives the cleaning kit to clean the optical fiber array.

Based on the above, the silicon photonics wafer testing system may clean the optical surface of the optical fiber array before, during, or after processes such as optical coupling, optical testing, or opto-electronic testing by disposing the cleaning kit on the wafer prober, thereby achieving the effect of on-line cleaning. The operation avoids the situation where the optical fiber core (that is, the aforementioned part with an optical surface) of the optical fiber array is blocked by dirt or dust particles, preventing light transmission and causing testing errors in the above processes. The silicon photonics wafer testing system, due to the aforementioned cleaning function, may provide time for timely problem identification and reconfiguration of the optical fiber array and testing system when testing anomalies occur.

### BRIEF DESCRIPTION OF THE DRAWINGS

FIG. 1 is a schematic diagram of a silicon photonics wafer testing system according to an embodiment of the disclosure.

FIG. 2 is a flowchart of a cleaning method according to an embodiment of the disclosure.

FIGS. 3 and 4 are schematic diagrams of the silicon photonics wafer testing system in FIG. 1 in different states.

FIG. 5 is a schematic diagram of the silicon photonics wafer testing system according to another embodiment of the disclosure.

FIG. 6 is a schematic diagram of the silicon photonics wafer testing system according to another embodiment of the disclosure.

FIG. 7 is a schematic diagram of the silicon photonics wafer testing system according to another embodiment of the disclosure.

FIG. 8 is a schematic diagram of the silicon photonics wafer testing system in FIG. 7 performing optical coupling and testing.

### DESCRIPTION OF THE EMBODIMENTS

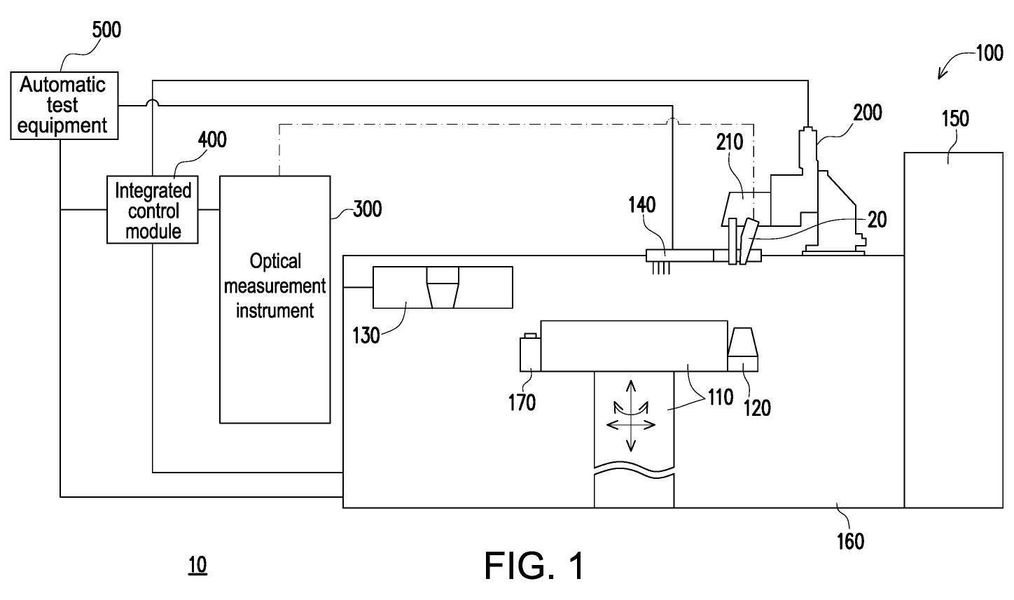

FIG. 1 is a schematic diagram of a silicon photonics wafer testing system according to an embodiment of the disclosure. Referring to FIG. 1, in this embodiment, a silicon photonics wafer testing system 10 includes a wafer prober 100, an optical coupling actuator 200, an optical measurement instrument 300, an integrated control module 400, and an automatic test equipment (ATE) 500. The integrated control module 400 is electrically connected to the wafer prober 100, the optical coupling actuator 200, and the optical measurement instrument 300, and may drive each of the components. The automatic test equipment 500 is integrated with the wafer prober 100 and electrically connected to the integrated control module 400, so as to allow the integrated control module 400 to drive the automatic test equipment 500 to test the electrical characteristics or opto-electronic characteristics of the silicon photonics wafer.

The wafer prober 100 includes a stage 110, an upward-facing camera 120, a downward-facing camera 130, a probe card 140, a wafer transporter 150, a probe testing platform 160, and a cleaning kit 170. The optical coupling actuator 200 is disposed on the probe testing platform 160, the optical fiber array 20 is adapted to be loaded on the fiber holder 210 of the optical coupling actuator 200 and is located in an optical path (shown by the dash-dot line in the figure) of the optical measurement instrument 300, so as to facilitate optical fiber transmission through multiple optical fiber cores in the optical fiber array 20. The wafer transporter 150 is disposed beside the probe testing platform 160, the stage 110 and the downward-facing camera 130 are movably disposed within the probe testing platform 160, and the upward-facing camera 120 and the cleaning kit 170 are respectively disposed on opposite sides of the stage 110 to move with the stage 110. As shown in FIG. 1, the probe card 140 is disposed on the probe testing platform 160 and electrically connected to the automatic test equipment 500, while the optical fiber array 20 loaded on the fiber holder 210 passes through the probe card 140 and extends into the probe testing platform 160 from top to bottom, and the cleaning kit 170 is positioned within the probe testing platform 160 from bottom to top. The aforementioned electrically connected integrated control module 400 and wafer prober 100 essentially allow the integrated control module 400 to smoothly drive the components of the wafer prober 100.

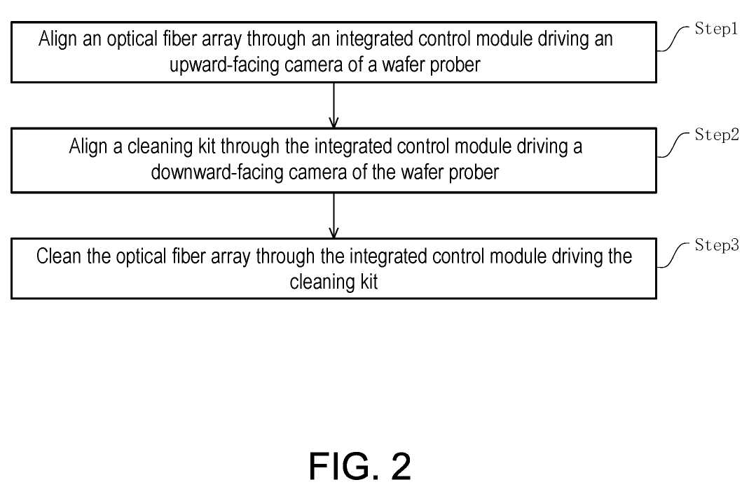

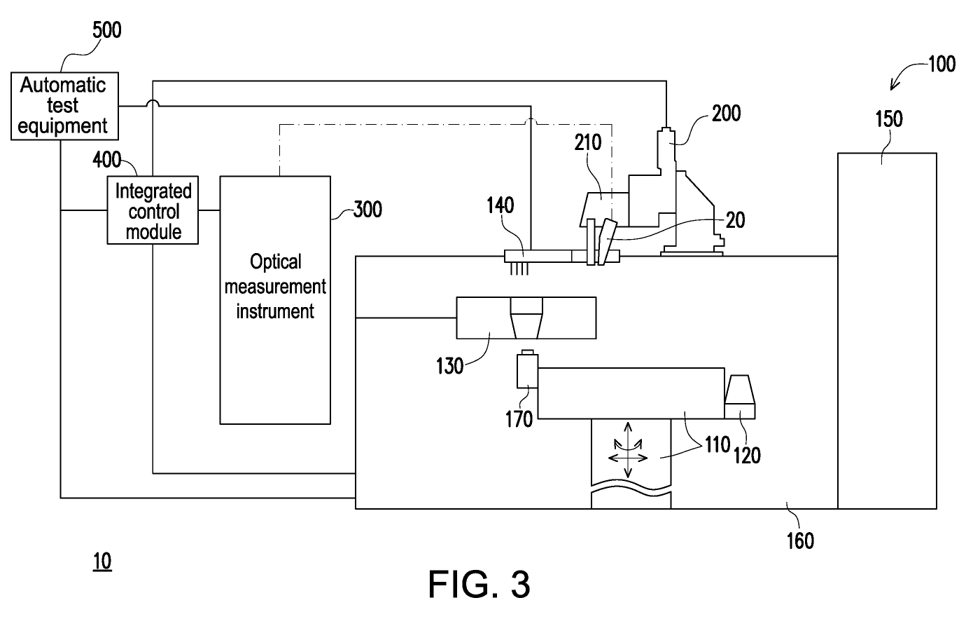

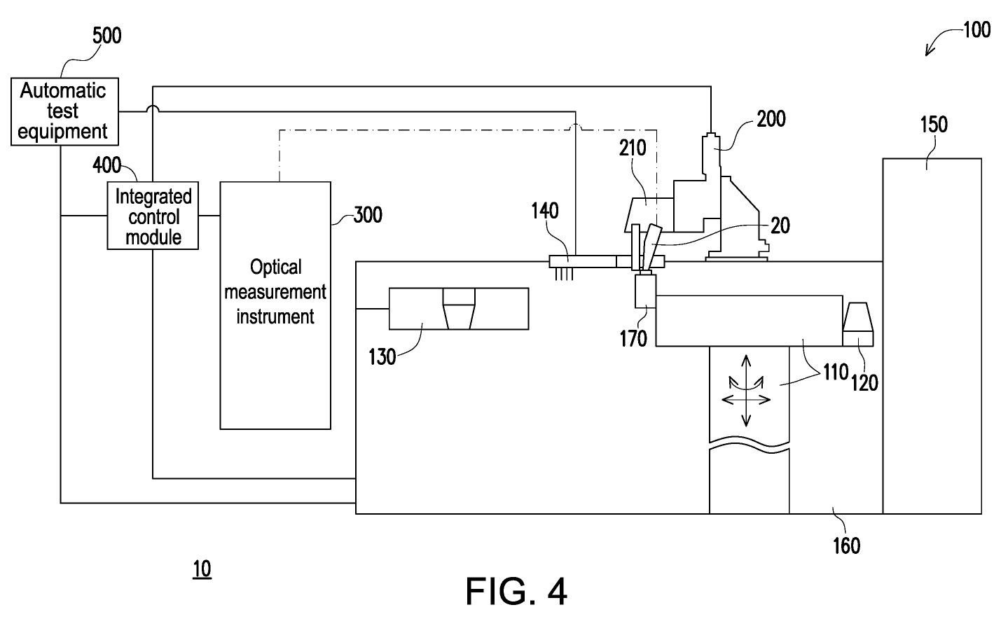

FIG. 2 is a flowchart of a cleaning method according to an embodiment of the disclosure. FIGS. 3 and 4 are schematic diagrams of the silicon photonics wafer testing system in FIG. 1 in different states. Referring to FIG. 2 and correspondingly to FIGS. 1, 3, or 4, based on the above component configuration, the cleaning method of the silicon photonics wafer testing system 10 includes the following. Step 1, the optical fiber array 20 is aligned through the integrated control module 400 driving the upward-facing camera 120 of the wafer prober 100. Step 2, the cleaning kit 170 is aligned through the integrated control module 400 driving the downward-facing camera 130 of the wafer prober 100. Also, an optical surface of the optical fiber array 20 is cleaned through the integrated control module 400 driving the cleaning kit 170.

In detail, please first refer to FIGS. 1 and 2. Since the stage 110 of this embodiment is a movable stage, for example, a rotary stage able to lift/descend and moving along a plane (the plane is perpendicular to the figure) within the probe testing platform 160, and further capable of rotation along a lifting/descending axis (the vertical axis shown in the figure). Therefore, the integrated control module 400 may smoothly drive the upward-facing camera 120 and the cleaning kit 170 to move within the internal space of the probe testing platform 160 through the stage 110. Accordingly, in Step 1 (and FIG. 1), since the optical fiber array 20 is loaded on the fiber holder 210, while the optical coupling actuator 200 is fixed on the probe testing platform 160, the optical surface of the optical fiber array 20 is already within a predetermined range with respect to the probe testing platform 160. Therefore, Step 1 may move the upward-facing camera 120 to the predetermined range through the stage 110 to locate the optical fiber array 20, and accordingly obtain position coordinates of the optical fiber array 20 (the optical surface thereof) with respect to the probe testing platform 160.

Next, referring to FIGS. 2 and 3, in Step 2, the integrated control module 400 then drives the downward-facing camera 130 to move toward the cleaning kit 170, and accordingly obtains position coordinates of the cleaning kit 170 with respect to the probe testing platform 160. Since the cleaning kit 170 is disposed beside the stage 110, the position relationships thereof with respect to the stage 110 and the stage 110 with respect to the probe testing platform 160 are already known, and thus the downward-facing camera 130 may quickly execute the Step. In this embodiment, to facilitate the downward-facing camera 130 to quickly obtain the position of the cleaning surface of the cleaning kit 170, the cleaning kit 170 of this embodiment may further be assembled on the side of the stage 110 in a vertically movable manner through a driving mechanism, and accordingly drive the cleaning kit 170 to lift and protrude from the surface of the stage 110 during alignment.

Following Step 1 and Step 2, once the corresponding position coordinates of the optical fiber array 20 and the cleaning kit 170 with respect to the probe testing platform 160 are known, the integrated control module 400 may integrate the coordinates to obtain the corresponding relationship between the cleaning kit 170 and the optical fiber array 20. Then, as shown in FIG. 4 and described in Step 3, through driving the stage 110 and the driving mechanism, the cleaning kit 170 protruding from the stage 110 is moved toward the optical fiber array 20, and the cleaning kit 170 contacts the optical surface of the optical fiber array 20. Since the cleaning surface of the cleaning kit 170 is adhesive, it facilitates the removal of dust or contamination from the optical surface of the optical fiber array 20 by making contact and through a vertical displacement adhesion method. It should also be mentioned that the contact method may be executed at least once to facilitate improved cleaning efficiency. In another embodiment, the cleaning kit 170 may also achieve a cleaning effect by scraping, by horizontal displacement, the optical surface of the optical fiber array 20 through the horizontal displacement of the stage 110.

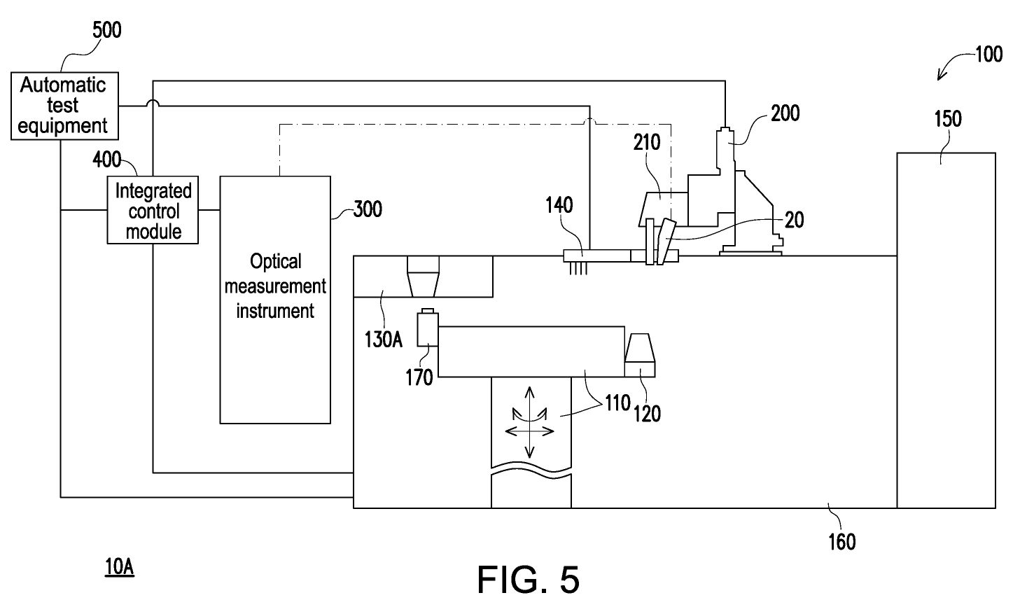

FIG. 5 is a schematic diagram of the silicon photonics wafer testing system according to another embodiment of the disclosure. Referring to FIG. 5, different from the previous embodiment, in this embodiment of a silicon photonics wafer testing system 10A, a downward-facing camera 130A is fixed on the inner left side of the probe testing platform 160, and thus Step 2 in this embodiment needs to be changed to the following. The integrated control module 400 drives the stage 110 to cause the cleaning kit 170 to move beneath the downward-facing camera 130, and then performs alignment of the cleaning kit 170.

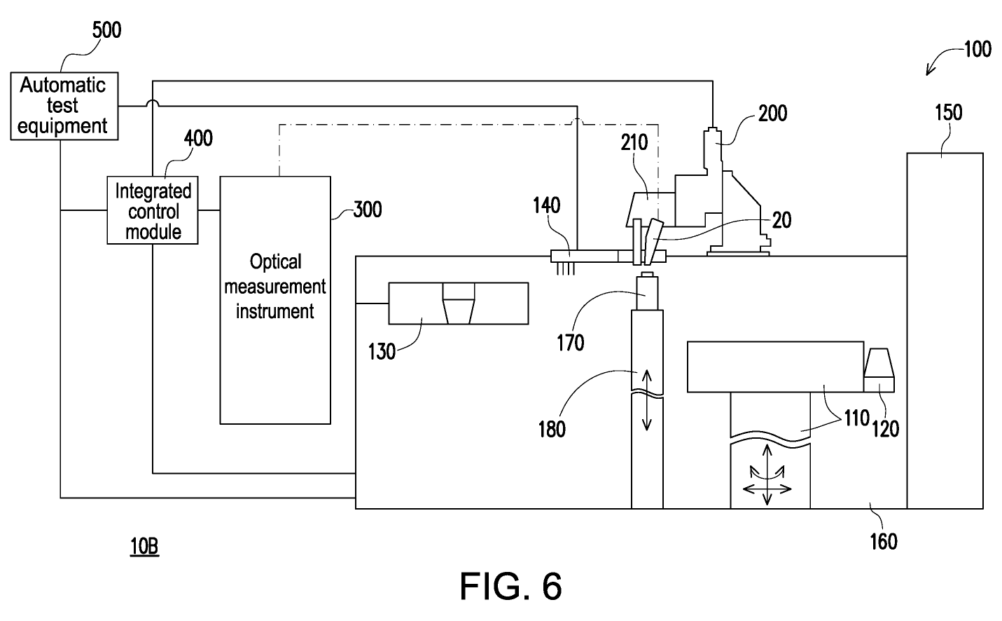

FIG. 6 is a schematic diagram of the silicon photonics wafer testing system according to another embodiment of the disclosure. Referring to FIG. 6, different from the previous embodiment, the wafer prober 100 of a silicon photonics wafer testing system 10B includes an lifting/descending 180 in addition to the stage 110, the cleaning kit 170 is disposed on the lifting/descending 180 and moves up and down within the probe testing platform 160 to contact or move away from the optical fiber array 20. Accordingly, in this embodiment, Step 2 further involves moving the downward-facing camera 130 to a corresponding position of the lifting/descending 180 to align the cleaning kit 170 thereon. In this embodiment, since the upward-facing camera 120 is still disposed on the side of the stage 110, when executing Step 1, the lifting/descending 180 needs to be driven first to lower the cleaning kit 170 below the height of the stage 110, so as to facilitate the rotation and elevation of the stage 110 to move the upward-facing camera 120 to the corresponding position of the optical fiber array 20. Finally, after completing the alignment, in Step 3, the integrated control module 400 drives the lifting/descending 180 to allow the cleaning kit 170 to clean the optical surface of the optical fiber array 20.

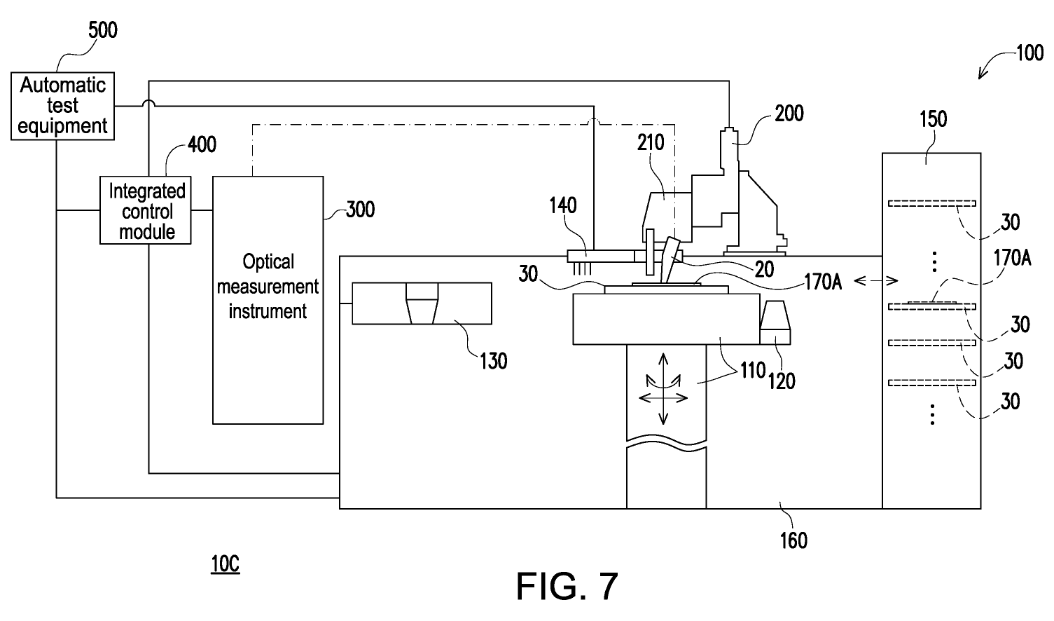

FIG. 7 is a schematic diagram of the silicon photonics wafer testing system according to another embodiment of the disclosure. Referring to FIG. 7, different from the previous embodiment, in this embodiment of a silicon photonics wafer testing system 10C, a cleaning kit 170A is disposed on the stage 110 to move with the stage 110. Furthermore, the cleaning kit 170A is loaded on a wafer 30, then the wafer transporter 150 transports the wafer 30 to the probe testing platform 160 and loads on the stage 110, and after cleaning, the wafer transporter 150 unloads the wafer 30 (together with the cleaning kit 170A thereon) from the stage 110 and returns to the wafer transporter 150. Accordingly, Step 2 is changed to the following. The integrated control module 400 drives the downward-facing camera 130 to align the wafer 30 and the cleaning kit 170A thereon, and subsequent Step 3 is changed to the following. The stage 110 is lifted to allow the cleaning kit 170A on the wafer 30 to contact the optical fiber array 20.

As shown in FIG. 7, at this time, there are still many wafers 30 not disposed with the cleaning kit 170A in the wafer transporter 150, which means that the silicon photonics wafer testing system 10C may clean the optical fiber array 20 during the process of optical coupling, optical testing, or opto-electronic testing, that is, performing operations of on-line cleaning, without having to stop the aforementioned optical coupling or testing process.

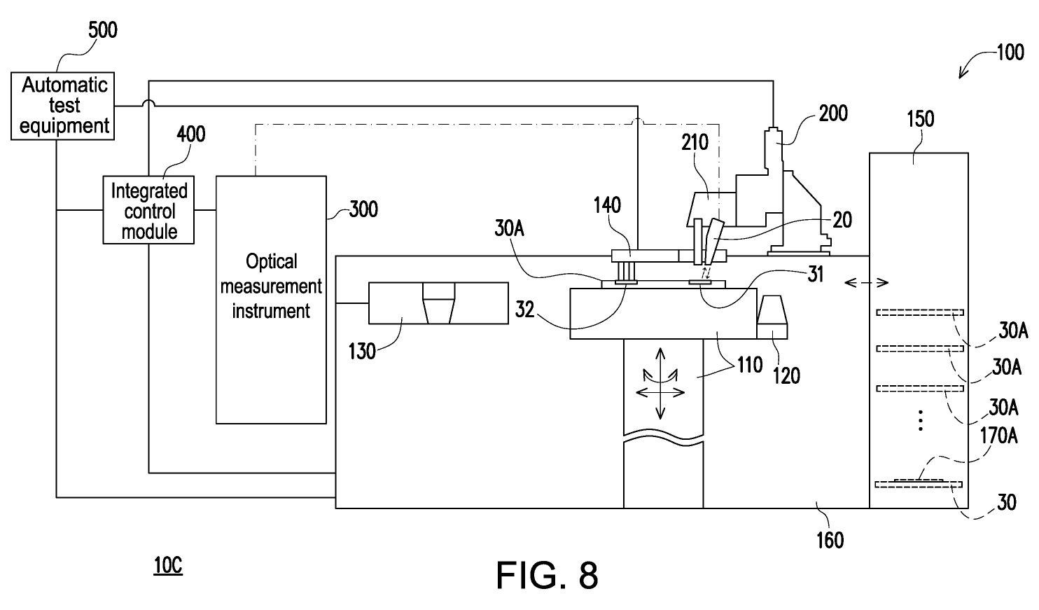

FIG. 8 is a schematic diagram of the silicon photonics wafer testing system in FIG. 7 performing optical coupling and testing. Comparing FIG. 7 and FIG. 8, taking the silicon photonics wafer testing system 10C as an example, it explains how the system may smoothly perform cleaning operations before, during, or after the formal process (that is, the aforementioned optical coupling, optical testing, or opto-electronic testing). As shown in FIG. 8, the integrated control module 400 has driven the optical measurement instrument 300, the optical coupling actuator 200, and the wafer prober 100 to perform optical coupling and testing on the wafer 30A on the stage 110, in which the optical fiber array 20 performs optical coupling with a coupler 31 (for example, a grating coupler or edge coupler) of the wafer 30A, and the probe card 140 of the wafer prober 100 has also contacted the bonding pad 32 of the wafer 30A to establish electrical connection therebetween. At this time, the wafer transporter 150 still stores multiple wafers 30A awaiting subsequent optical coupling and testing, and the wafer 30 with the same size specifications, that is, the wafer 30 carrying the cleaning kit 170A in FIG. 7, may also be stored together in the wafer transporter 150, thus it may smoothly clean the optical fiber array 20 during the process of optical coupling and testing. This cleaning action may also be performed at a fixed frequency.

In summary, in the foregoing embodiments of the disclosure, the silicon photonics wafer testing system may clean the optical surface of the optical fiber array before, during, or after processes such as optical coupling, optical testing, or opto-electronic testing by disposing the cleaning kit on the wafer prober, thereby achieving the effect of on-line cleaning. The operation avoids the situation where the optical fiber core (that is, the aforementioned part with the optical surface) of the optical fiber array is blocked by dirt or dust particles, preventing light transmission and causing testing errors in the above processes.

In one embodiment, the upward-facing camera for alignment and the cleaning kit are disposed on opposite sides of the movable stage, so as to allow the stage to drive the upward-facing camera to align with the optical fiber array, and the stage also drives the cleaning kit to clean the optical fiber array. In one embodiment, the downward-facing camera is fixed on the inner side of the probe testing platform, and thus the cleaning kit needs to be moved by the stage to beneath the downward-facing camera to facilitate alignment. In one embodiment, the cleaning kit is loaded on an independent lifting/descending shaft and separated from the stage, and thus the lifting/descending shaft and the stage need to coordinate with each other to facilitate the subsequent alignment action of the upward-facing camera and the cleaning action. In one embodiment, the cleaning kit is disposed on the wafer, and thus the wafer prober 100 may load the wafer with the cleaning kit on the stage through the wafer transporter 150 to perform cleaning, and move the wafer and the cleaning kit thereon away from the stage after cleaning.

Accordingly, the silicon photonics wafer testing system, due to the aforementioned cleaning function, may provide time for timely problem identification and reconfiguration of the optical fiber array and testing system when testing anomalies occur.

What is claimed is:

1. A cleaning method of a silicon photonics wafer testing system, wherein the silicon photonics wafer testing system comprises a wafer prober, an optical coupling actuator, and an integrated control module, the integrated control module is electrically connected to the wafer prober and the optical coupling actuator, the wafer prober comprises a probe testing platform, a cleaning kit, an upward-facing camera, and a downward-facing camera, the optical coupling actuator is disposed on the probe testing platform, an optical fiber array is loaded on the optical coupling actuator, the upward-facing camera and the downward-facing camera are respectively disposed within the probe testing platform, the optical fiber array extends into the probe testing platform from top to bottom, the cleaning kit is disposed within the probe testing platform from bottom to top, and the cleaning method comprises:
aligning the optical fiber array through the integrated control module driving the upward-facing camera of the wafer prober;
aligning the cleaning kit through the integrated control module driving the downward-facing camera of the wafer prober; and
cleaning the optical fiber array through the integrated control module driving the cleaning kit.

2. The cleaning method of the silicon photonics wafer testing system as claimed in claim 1, wherein the wafer prober further comprises a stage movably disposed within the probe testing platform, the cleaning kit is disposed on a side of the stage to move with the stage, and the cleaning method comprises:
driving, by the integrated control module, the stage, to cause the cleaning kit to clean the optical fiber array.

3. The cleaning method of the silicon photonics wafer testing system as claimed in claim 2, wherein the upward-facing camera is disposed on another side of the stage to move with the stage and is opposite to or adjacent to the cleaning kit, and the cleaning method comprises:
driving, by the integrated control module, the stage, to cause the upward-facing camera to align the optical fiber array.

4. The cleaning method of the silicon photonics wafer testing system as claimed in claim 2, wherein the cleaning kit is assembled on the side in a vertically movable manner, and the cleaning method comprises:
driving, by the integrated control module, the cleaning kit to lift with respect to the stage and protrude from the stage to clean the optical fiber array.

5. The cleaning method of the silicon photonics wafer testing system as claimed in claim 2, wherein the downward-facing camera is fixed on an inner side of the probe testing platform, and the cleaning method comprises:
driving, by the integrated control module, the stage, to cause the cleaning kit to move beneath the downward-facing camera.

6. The cleaning method of the silicon photonics wafer testing system as claimed in claim 1, wherein the wafer prober further comprises a lifting/descending shaft and a stage movably disposed within the probe testing platform respectively, the cleaning kit is disposed on the lifting/descending shaft, the upward-facing camera is disposed on a side of the stage, and the cleaning method comprises:
driving, by the integrated control module, the stage, to cause the upward-facing camera to align the optical fiber array; and
driving, by the integrated control module, the lifting/descending shaft, to cause the cleaning kit to clean the optical fiber array.

7. The cleaning method of the silicon photonics wafer testing system as claimed in claim 1, wherein the wafer prober further comprises a stage movably disposed within the probe testing platform, the cleaning kit is disposed on the stage to move with the stage, and the cleaning method comprises:
driving, by the integrated control module, the stage, to move toward the optical fiber array, to cause the cleaning kit to clean the optical fiber array.

8. The cleaning method of the silicon photonics wafer testing system as claimed in claim 7, wherein the cleaning kit is disposed on a wafer, the wafer is loaded on the stage, and the cleaning method comprises:
driving, by the integrated control module, the upward-facing camera, to align the wafer and the cleaning kit.

9. The cleaning method of the silicon photonics wafer testing system as claimed in claim 7, wherein the upward-facing camera is disposed on a side of the stage.

10. The cleaning method of the silicon photonics wafer testing system as claimed in claim 1, performed during a process of optical coupling, optical testing, or opto-electronic testing of the silicon photonics wafer testing system.

11. The cleaning method of the silicon photonics wafer testing system as claimed in claim 1, wherein the integrated control module drives the cleaning kit to scrape, by horizontal displacement, the optical fiber array.

12. The cleaning method of the silicon photonics wafer testing system as claimed in claim 1, wherein the integrated control module drives the cleaning kit to adhere, by vertical displacement, to the optical fiber array.
